(19) United States
(12) Patent Application Publication
(10) Pub. No.: US 2008/0162154 A1
(43) Pub. Date: Jul. 3, 2008

(54) System and Method for Vehicle Advertising Network

(76) Inventors: Gene S. Fein, Lenox, MA (US); Edward Merritt, Lenox, MA (US)

Correspondence Address: Stolowitz Ford Cowger LLP, 621 SW Morrison St, Suite 600, Portland, OR, 97205, US

(21) Appl. No.: 11/617,385

(22) Filed: Dec. 28, 2006

(51) Int. Cl. G06Q 30/00

(52) U.S. Cl. 705/1

(57) ABSTRACT

Disclosed is an advertising and marketing network where vehicles (especially traveling ones) are the advertising and marketing medium. Advertisers pay for a package where a certain number of vehicles display advertisement approved by the advertiser for a certain number of advertising impressions based upon average traffic on monitored roadways at specific times. The advertising is removeably affixed to vehicles. In one embodiment, this is accomplished by network personnel/vehicle operator at a designated toll booth/private or public facility adjacent to the monitored road area. The advertising is coupled to a tracking transponder that is read at different road points to generate specific credits for the advertiser and vehicle operator. Participating vehicle operators receive credit that may be used to either offset toll costs or to generate cash/credit at other participating businesses, municipalities, and the like. Municipalities and private institutions enabling the invention network may also reap a portion of the profits.

### BACKGROUND OF THE INVENTION

It is well known that vehicles have been affixed with advertising to carry an advertising or marketing message to fellow drivers, passengers or onlookers. These marketing messages may be delivered via a skin of advertising that is affixed to a vehicle or by permanently painting the advertising to a vehicle. Advertisers use this mode of advertising among their employees or via contracted vehicles that are known or contracted by the advertising party to travel in a desired locus or location. The advertiser or marketer derives a specific benefit not only from the advertising being seen by people, but also by being seen within locations that comprise specific demographic elements, sometimes during specific times of day that the advertiser may be seeking to reach what the advertiser views as their target audience for the advertising.

Currently, the process of affixing vehicles with advertising or marketing messages is a very incremental and piecemeal undertaking. The focus in this industry has been on large format advertising on large vehicles, i.e., vans or trucks, or on fixed advertising for regular sized automobile vehicles. This kind of fixed advertising is common on rental car vehicles or on small business vehicles from landscaping to food delivery.

Conventional models have vehicles being painstakingly affixed with advertising on either a permanent or semi-permanent basis raising the cost of implementing the advertising as well as the inconvenience of the one vehicle for one custom set of fitting advertising display materials. There is also a limited current distribution base of vehicles to carry advertising because there is no vehicle advertising network that has access to millions of vehicles with a simple way to outfit the vehicles with advertising and compensate the vehicle operators for their agreement to display such advertising.

Unfortunately, because of the dearth of distribution to large numbers of vehicles and the cost associated with outfitting single vehicles on a custom made basis, the industry of advertising on individual vehicles has yet to take hold on a large scale distribution basis.

### SUMMARY OF THE INVENTION

Accordingly, the present invention allows for advertisers to have easy access to millions of participating vehicles each day to display advertising upon. Popular advertising design formats are pre-manufactured as advertising modules on materials that enable easy removable affixing to participating vehicles (e.g., in seconds). The usage and display of that advertising is tracked electronically on the relevant roadways for accounting purposes. The advertising network allows for advertisers, vehicle operators, implementation staff, as well as private and public road owners to benefit.

In one embodiment, the present invention addresses the need felt in the prior art by providing a system and a method for advertising comprising: (i) at least one advertising module, where each conveys a particular advertisement and may be removeably affixed to a vehicle; (ii) a tracking assembly for tracking and recording travel of each advertising module; and, (iii) a data processing subsystem coupled to the tracking assembly. The ad module may be any of the following: a magnetic placard, an adhesive backed placard, an electro-static placard, a multi-piece placard, or any combination thereof. The tracking assembly may include for each ad module: a data signal generator for generating a digital signal and a plurality of data readers spaced along roadways being traveled by the participating vehicle. The tracking assembly may also be a toll road payment system. The data signal generator may be a transponder coupled to one of the ad module and the participating vehicle. Each data reader may record any combination of location, date, time of travel, and the like, for either the advertising module, the participating vehicle, or any combination thereof. The data readers may also be located at toll booths. The compensation to the vehicle operator may be in credits toward roadway tolls.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of an advertisement module (placard) of the present invention that can be removeably affixed to a vehicle.

FIG. 2 illustrates a vehicle inside the customer service transaction processing booth of the present invention.

FIG. 3 illustrates the process disclosed by the present invention of removeably affixing the advertisement module to a participating vehicle.

FIG. 4 is a schematic illustration of some locations where advertising modules may be affixed to a vehicle for use in the present invention.

FIG. 5 illustrates the present invention action of removeably affixing advertising modules (placards) to the front of a vehicle at a service area.

FIG. 6 is a schematic illustration of the possible locations on participating vehicles where transponder units or radio frequency identification tags can be affixed as an embedded element in the advertising module or as a separate entity to track advertising usage according to the present invention.

FIG. 7 is a schematic illustration of the present invention process of the transponder being read from the participating vehicle and the obtained data transferred to a central database.

FIG. 8 is a block diagram of the compensation model of the Vehicle Advertising Network System.

FIG. 9 is a process flow diagram of a Vehicle Advertising Network System of the present invention.

FIG. 10 is a schematic view of a computer environment in which the principles of the present invention may be implemented.

FIG. 11 is a block diagram of the internal structure of a computer from the FIG. 10 computer environment.

### DETAILED DESCRIPTION OF THE INVENTION

A description of example embodiments of the invention follows.

The present invention, in accordance with one embodiment relates to the creation of an advertising and marketing network where participating vehicles (especially in travel or traveling ones) are the medium by which advertising and marketing messages are displayed. Credit is given for the participating vehicle displaying the advertisement by an electronic confirmation via a transponder that is read at network checkpoints in a manner similar to that of how FastLane vehicles are accounted for distance traveled from point to point. Portable advertising or marketing message graphic “skins” are removeably attached to vehicles in the invention network, For a given participating vehicle, the graphic skin is positioned on the vehicle's body such that the advertising or marketing message is maximally or otherwise displayed strategically by the vehicle as it travels on roadways. A transponder sewing as an electronic tag (or confirmation) is embedded inside the graphic skin and is read by a transponder system at checkpoints to determine distance traveled by the vehicle and hence miles of the vehicle having displayed the advertisement. The credit generated for the vehicle displaying the graphic skin (advertisement module) over a specific number of miles of roadway during a specific time period, may be used as an offset in toll costs or may be accumulated in a participating vehicle operator's account for later distribution of a check or credit to a participating vehicle operator's bank or digital account, such as PayPal.

To accomplish the above, a Vehicle Advertising (Ad Lane) Network of the present invention may be integrated into toll booths by defining a specific Ad Lane for participating vehicles to drive through to have the advertisement placard (graphic skin) removeably affixed to their vehicle by an attendant or via a self-service method. The advertisers are engaged in the system by an Ad Lane agency, who makes a number of printing and display options available to advertisers. In one embodiment, the Ad Lane agency employs a menu of costs for various advertising campaigns or programs including gross impressions, and levels of ads and deployment specificity. For example, display of basic logos on any participating vehicle being the easiest to fulfill and thus least expensive and display involving special printing to be allocated onto specific vehicles with specific drivers and specific vehicle colors, over specific roadways, during specific times increasing the cost of the advertising program.

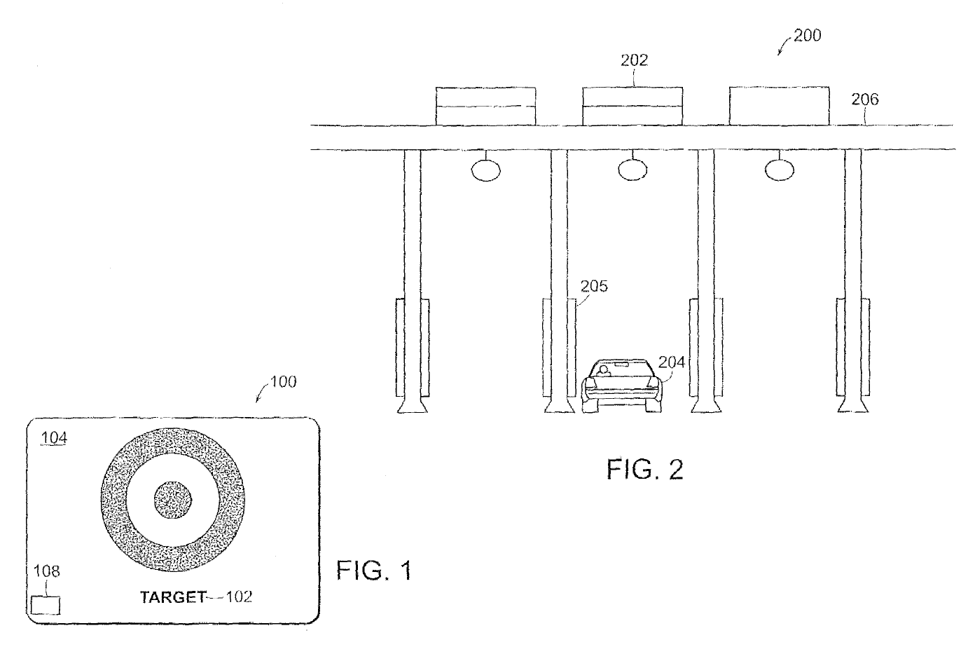

FIG. 1 illustrates an example of an advertising placard 100 that may be contracted to be removeably affixed to a vehicle. This example is of an advertisement for Target. The example placard 100 displays the company logo emblazoned on the front surface 102 of the placard that is magnetically, adhesively, or similarly removeably bound to the vehicle. The magnetic variety of signage may be quickly applied to the vehicle due to a large portion, if not all, of the ad placard 100 being covered by magnetic material on the back surface 104. The flexible nature of the magnetic material may allow the placard 100 to be stacked or rolled off of a sheet of pre-printed magnet placards that may be torn off (separated from) the sheet either by hand or with scissors like a large paper towel. An ionized charge may also hold a lighter weight solution to the adhesion of the advertising placard 100 by using static electricity and known adhesion characteristics of polymers from a vehicle and placard. Such would enable the placard 100 and vehicle to adhere together smoothly without the use of glues. Rolls or sheets of ad placards 100 may contain a single advertisement repeated over and over again or may contain multiple advertisements repeated in sequence. The ad placards 100 may also be printed from printers located at service center sites, which may be connected to a main frame global computer network or virtual private network that can send out and receive print orders on demand to regulate the flow of ad placard inventory creation and deployment to exacting standards.

The ad placards 100 may be embedded with or otherwise coupled to radio frequency identification (RFID) tags or transponder units 108 that allow the ad placards 100 to be tracked utilizing existing art (techniques) for tracking travel, dates and times for the Ad Lane Network. For example, existing highway tracking systems, like FastLane, or a new tracking reader system deployed throughout roadways to be tracked by the Ad Lane Network may be employed. Such readers are positioned to log the possible entry and exit points from a roadway that is part of the Ad Lane Network. If a roadway is annexed to another roadway that is part of the Ad Lane Network, then that roadway is also equipped with readers to log the distance (location), time and date of Ad Lane vehicles and specific Ad Lane placards 100 on display. All or certain reader stations may also be equipped with digital photo/imaging capabilities triggered by a verified reading to ensure that advertising is being displayed on the vehicle correctly and not stored inside the vehicle but still triggering the transponder or RFID reader.

Each time the vehicle passes a transponder or RFID reader, the vehicle transponder or RFID signal is read (obtained) by the reader to track the data elements (distance (location), time, day, and/or date of travel). Each of the data elements is logged by a specific embedded transponder or RFID signal in a specific advertisement (i.e., advertisements are uniquely identified in the logging of data elements). The data elements of a single class of advertisements, such as a Target ad, is then added up to tabulate the number of gross impressions generated by the present invention network. Advertisers can pay for a certain amount of impressions or for a certain amount of distance (number of miles) covered or a set plan encompassing a certain number of vehicles over a certain number of days. Each plan is capable of being tracked (viewed) in real time and up to the minute reports are able to be generated and/or made available via a global computer network for Ad Lane customers.

The specific transponder or RFID signal 108 of an ad placard 100 is linked, at the time of removeably affixing the ad placard 100 to a vehicle, to that vehicle's license plate number, which serves as its tracking number in the present invention network. The billing system for the vehicle operator's bank account, PayPal account, and other payment form or toll road credit is then matched with the vehicle license plate number that is used to credit the vehicle operator for his share of revenue for participating in the Ad Lane Network as a source of advertising display.

Restated, each ad placard 100 has a signal generator means that indicates or otherwise uniquely identifies the ad placard 100, or the participating vehicle to which the ad placard 100 is removeably attached or any combination thereof. The signal generation means can be any of the following: radar, RFID or transponder 108, and the like. The signal generation means is embedded, coupled to, or otherwise associated with the ad placard 100 as installed (removeably affixed) on a participating vehicle.

The inception of the Ad Lane process for a vehicle begins at an Ad Lane customer service center 200, either at a roadway toll booth 206 or other service center that is a part of or adjacent to an Ad Lane Network route, as illustrated in FIG. 2. At the customer service center 200 herein depicted at a toll booth 206, there is a specific lane marked as an Ad Lane eligible toll booth 202. At the service center 200, the participating vehicle 204 may be registered for the invention network and have an ad module 100 removeably affixed by a service center representative 302 or by the vehicle operator in a self-service situation 205 (i.e., eligible for both kinds of deployment) at the designated lane. The toll booths 206 also serve as a reading station to log the distance, time, and date of existing deployed advertising (i.e., placards 100 currently carried or displayed by a participating vehicle 204). At the time of initial signup and deployment, the license plate number corresponding to the vehicle 204 is used and the default system setting enables the vehicle 204 to be credited for tolls due, where the invention network functions as a part of a toll road system. A registration may then be completed via a global computer network by the vehicle operator, or at the customer service center 200 if time and circumstance allow it, that enable the vehicle user/operator to have monies earned from the Ad Lane Network deposited to his or her bank account, used as a credit for participating retailers or credited onto certain credit cards, PayPal type of accounts, other electronic funds transfer accounts, and the like.

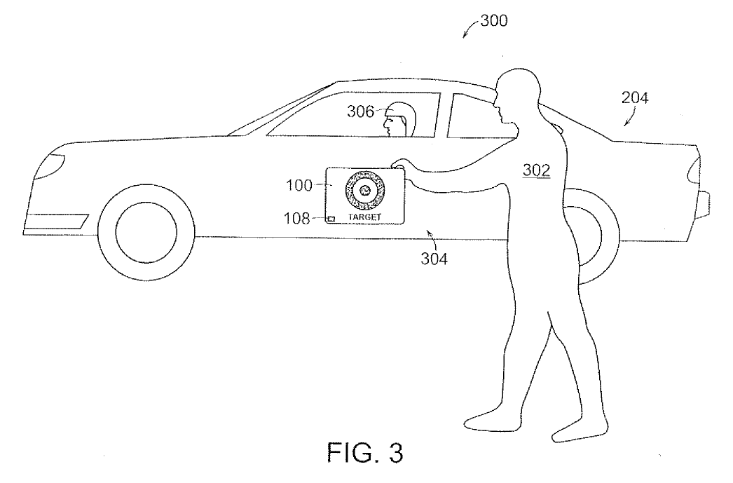

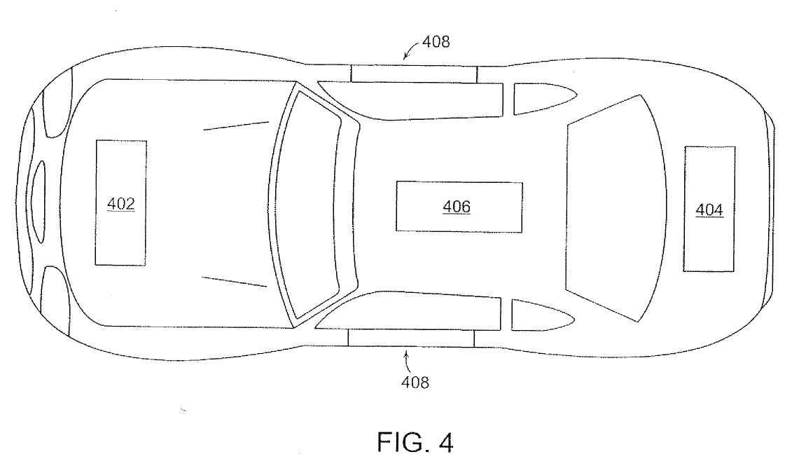

FIG. 3 illustrates the process 300 of removeably affixing the advertisement module (placard) 100 to a participating vehicle 204, such as at a customer service center 200 (e.g., toll booth designated lane 205) as described above. The figure shows an example of a service station attendant 302 removeably affixing a piece of Ad Lane advertising placard 100 to the side 304 of the participating vehicle 204 while the operator 306 of that vehicle waits inside the vehicle 204.

Illustrated in FIG. 4 are a multitude of locations or positions on a participating vehicle where advertising placards 100 may be removeably affixed. An advertising placard 100 is removeably affixed to the hood 402 of a participating vehicle 204. Similarly placards 100 can be removeably affixed to an upper planar surface of the trunk 404 of a participating vehicle 204, on top of the roof 406, or, as previously shown in FIG. 3, on the vertical side of either door 408 of the vehicle.

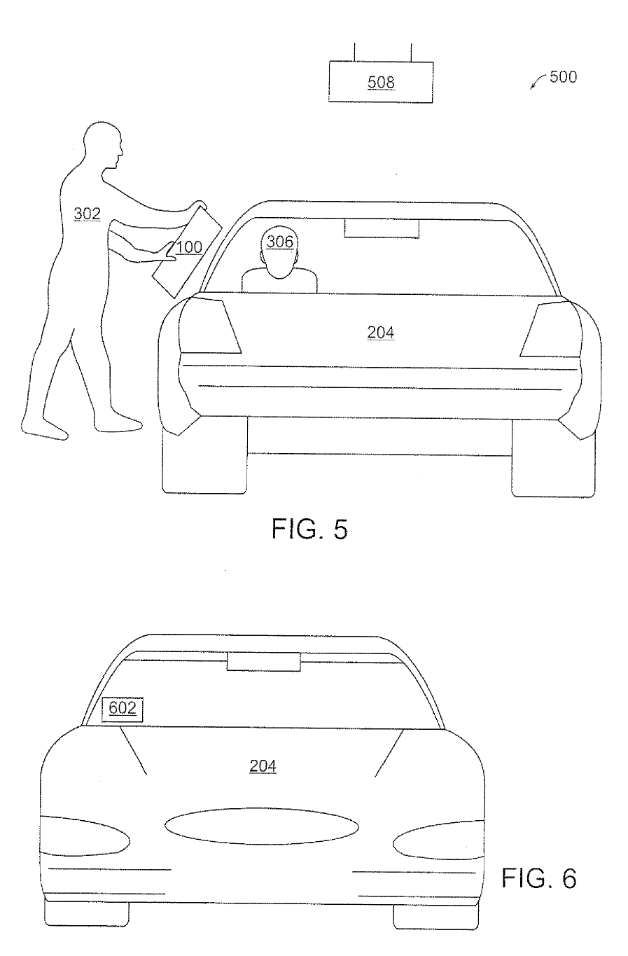

FIG. 5 illustrates how easy it is for a service attendant 302 to removeably affix one of the ad placards 100 to a participating vehicle 204 at a customer service center 200. The entire process of removeably affixing the placard 100 to the vehicle 204 can be completed in a matter seconds, not much longer than a stop at a conventional toll booth. This example 500 is carried out at a customer service center station (or toll booth lane 205) clearly marked with an overhead Ad Lane sign display 508, which may be illuminated. The ads themselves may be printed on a clear material using the static polymer bonding method and then specific colors may be used as a stand alone design, such as flames, which would otherwise not appear to be cohesive in a block form, solid-colored ad placard format.

FIG. 6 illustrates the possible locations on participating vehicles 204 where transponder units or radio frequency identification tags (signal generator) 108 can be affixed as an embedded element in the advertising placard 100 or as a separate entity to track advertising usage (display). By the figure, it is possible that the invention network transponder or RFID 108 can be mounted inside 602 the participating vehicle 204. This enables flexibility in embodiments of the invention network to be a dual transponder system with one transponder or RFID signal generator 108 embedded in the advertising module 100 and one on the inside 602 of the participating vehicle 204 for toll road payment systems, or a single transponder system located inside the participating vehicle 204 that can run dual functions and tracking report services with a toll road payment system, such as FastLane. Specifically, integration with FastLane would allow for easy credits for tolls based upon the vehicle operators' credits earned by participation in the Ad Lane system (advertising network) of the present invention.

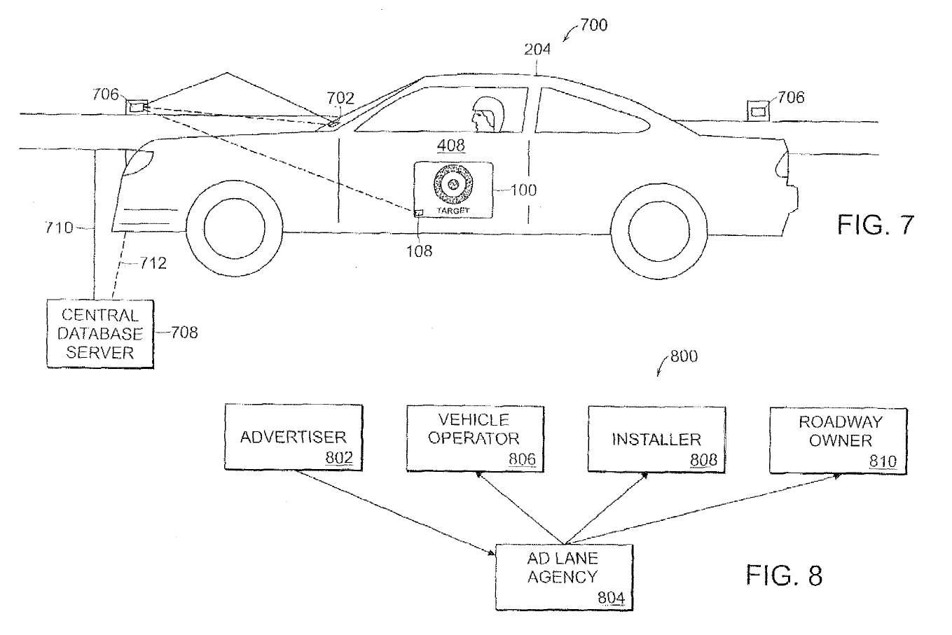

FIG. 7 illustrates the integration 700 of multiple signal senders. There is one transponder 702 in the windshield of the participating vehicle 204 and another embedded transponder 108 in the ad placard 100 on the side door 408 of the participating vehicle 204. The transponders 702 and 108 are read by the system readers 706 enabling the obtained (read) data to be passed to a central database server 708 either via a secure wired 710 or wireless 712 connections. Subsequent retrieval of the data from the central database by the central database server 708 is used: (i) to generate reports for accounting to the network owners vehicle participants, and advertisers; (ii) to generate royalty statements; and, (iii) as an accounting verification tool (means) to disburse funds.

In one embodiment, the central database comprises tables that maintain records per ad module 100. The records are keyed or indexed by the unique identifiers of the ad modules 100. In a record of a given ad module 100, there is an entry for each reading by a signal reader 706 along the roadway traveled by the respective vehicle carrying the ad module 100. Each record entry includes the data elements (reader location, time, day, and/or date of travel). Another table provides the mileage between reader 706 locations, thus the database provides information regarding the miles traveled by each ad placard 100 as ported and displayed by a participating vehicle 204. Each entry in the database record of an ad module 100 further indicates the participating vehicle 204 to which the ad was attached during the reading for the entry. Additional tables indicate for each stretch of road between readers 706, the average number of onlookers (pedestrians, other vehicle drivers/passengers in the same flow of traffic and in opposite or cross directions, roadside people, etc.) for a given time of day per day of week. For purposes of compensation to a vehicle operator and cost accounting to an advertiser, the tables and records maintained in the central database support the invention system 800 generation of estimated number of impressions as a function of the roads traveled and data logged into the records of an ad module 100.

The compensation flow chart model for the Ad Lane Network 800 is illustrated in FIG. 8. The advertiser 802 contracts with the Ad Lane Agency 804 to have a certain placard display program activated which may be generic to place as many ad placards 100 on as many participating vehicles 204 throughout the Ad Lane Network or may be specified by defining variables, such as running the placards 100 over a certain stretch of roadways, during certain times, using participating vehicles 204 with certain colors bearing certain kinds of ad placards 100. The Ad Lane Agency 804 then collects the funds from the advertiser 802 and disburses the funds according to specific performance, billing, and contractual provisions to various stakeholders and participants in the network 800, including but not limited to, vehicle operators 806, installer and service (attendant) entities 808, and roadway owners and municipalities 810.

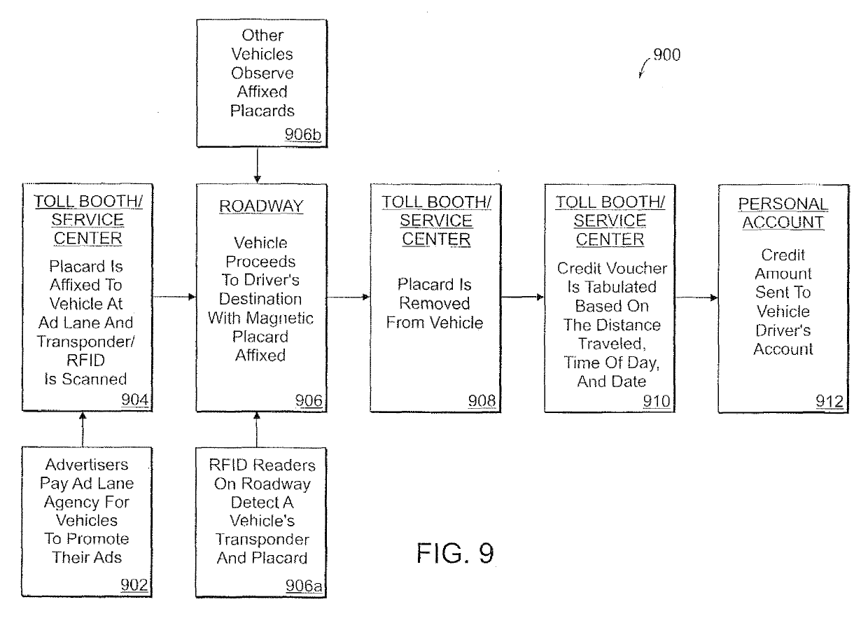

FIG. 9 illustrates a flow chart of the invention network 800 in practice where an advertiser has engaged the Ad Lane Network to place placards 100 on participating vehicles 204 according to Ad Lane available programs or specific advertiser parameters (step 902). A participating vehicle 204 is outfitted with a placard 100 and registered into the Ad Lane Network 800 at an Ad Lane toll booth 202, as described in FIGS. 2 and 5, or a customer service center (step 904). Participating vehicles 204 removeably affixed with the placards 100 then travel along designated roadways of interest to the advertiser (step 906) where signals sent from RFID or transponders 108 on the participating vehicle 204 are registered in readers 706 along roadways of the Ad Lane Network to validate distances covered by participating vehicles 204 (step 906a). During this process other vehicles' drivers and passengers, pedestrians and roadside onlookers view the advertising placards 100 on the participating vehicles 204 and garner impressions (step 906b). The impressions are accounted for via estimates by the Ad Lane Network based upon traffic levels and time of day as described above in FIG. 7. At the end of the advertising engagement the placard 100 is removed from the participating vehicle 204 at an Ad Lane toll booth 202 or independent service center (step 908). The final tally of value created from the participating vehicle's 204 travels is logged into the system at the toll booth 202 or service center (step 910), the ad placard 100 is removed, and the invention network 800 calculates a credit, if due, (step 912) as well as reconciles a total report for all parties involved, i.e., advertiser, vehicle operator, roadway owner, service center, etc. Monies are then distributed to stakeholders based upon what is due under the terms of the agreements with the different stakeholders (as described in FIG. 8 above).

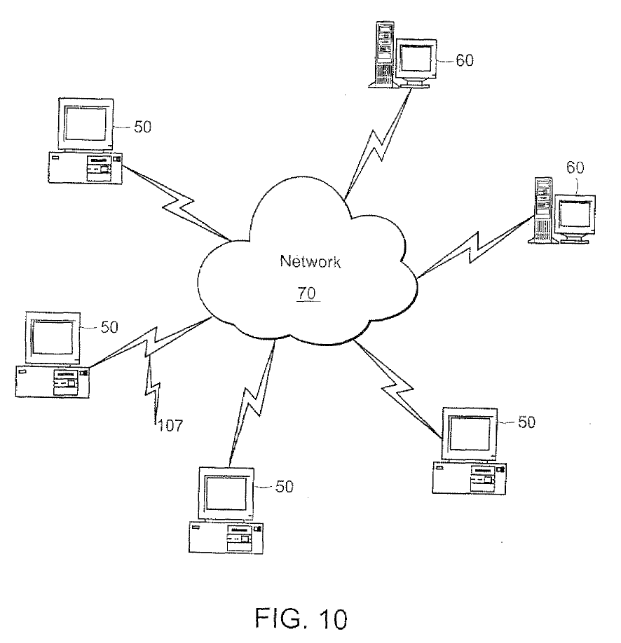

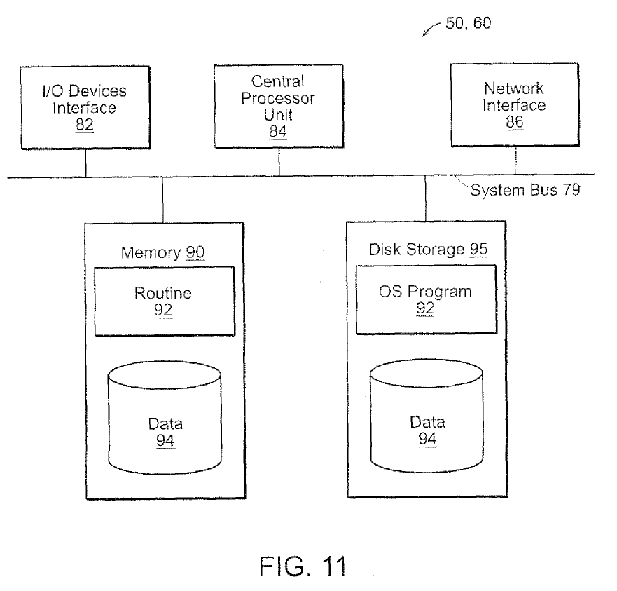

FIG. 10 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global computer network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 11 is a diagram of the internal structure of a computer (e.g., client processor/device 50 or server computers 60) in the computer system of FIG. 10. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 10), Memory 90 provides volatile storage for computer software instructions 92 and data 94 used to implement an embodiment of the present invention (e.g., central database records per ad module, supporting tables and impression estimation calculation). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention network. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global computer network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

Further, the present invention may be implemented in a variety of computer architectures. The computer network of FIGS. 10 and 11 are for purposes of illustration and not limitation of the present invention.

While this invention has been particularly shown and described with references to example embodiments thereof, it will be understood by those skilled in the art that various changes in form and details may be made therein without departing from the scope of the invention encompassed by the appended claims.

Common database systems are suitable for the central database server 708 and related functions discussed in FIG. 7. Various new or common algorithms for estimation of the number of impressions may be employed in Step 906b of FIG. 9. Counting the number of passing vehicles, vehicles and/or passengers throughput at toll booths, location-based approximate numbers of people per time of day and days of the week, and the like may be utilized.

As used herein, the terms “advertisement” and “ad” include marketing messages, business (as opposed to personal) messages whether commercial or non-commercial, public service messages, other messages, and the like. “Participating vehicle” or “vehicle” in most embodiments are non-commercial vehicles, which means, trucks, cars, motorized vehicles, and the like. With respect to ad placard 100 and respective signal generator 108, 702, the term “embedded” includes electronic coupling, removeably affixed, permanently attached, other association, and the like.

It is understood that more than one ad module 100 may be removeably affixed and displayed by a vehicle at a time. Respective transponder 108 of the plural ad modules 100 carried and displayed by the participating vehicle 204 are read by signal readers 706. Database records for each subject ad module 100 are maintained as described above and estimated impressions are calculated per ad module 100 displayed by the participating vehicle 204. The plural ad modules 100 may be for the same or different advertiser(s) 802. Various combinations of ad modules for ad campaigns may be employed by the invention network as in the purview of one skilled in the art given the foregoing description.

Further compensation to participating vehicle drivers or owners may be in the form of credit to government motor vehicle entities, credit against motor vehicle fines, and the like.

What is claimed is:

1. A system for advertising comprising:
at least one ad module, each ad module conveying a respective advertisement and configured to be removeably affixed to a vehicle;
a tracking assembly for tracking and recording travel of each ad module; and
a data processing subsystem coupled to the tracking assembly and, for a given ad module, using the recorded travel of the ad module to determine an advertising display value, the data processing subsystem enabling payment to an operator of a vehicle to which the given ad module was removeably affixed, the payment being based on the determined advertising display value.

2. A system as claimed in claim 1, wherein the tracking assembly includes for each ad module:
a data signal generator for generating a data signal effectively indicating the display of the respective advertisement by a certain vehicle, the certain vehicle being the vehicle to which the ad module is removeably affixed; and
a plurality of data readers spaced along roadways being traveled by the certain vehicle, each data reader obtaining the generated data signal and recording indication of travel of the corresponding ad module.

3. A system as claimed in claim 2, wherein each data reader records any combination of location, date, or time of travel.

4. A system as in claim 2, wherein the data signal generator is a transponder coupled to one of the ad module and the certain vehicle.

5. A system as claimed in claim 4, wherein the data readers are located at toll booths.

6. A system as in claim 1, wherein the ad module is any of a magnetic placard, an adhesive backed placard, an electro-static placard, or a multi-piece placard.

7. A system as claimed in claim 1, wherein the tracking assembly is a toll road payment system.

8. A system as claimed in claim 7, wherein payment to the vehicle operator is in credits toward toll road payment.

9. A method for advertising comprising the steps of:
providing at least one ad module, each ad module conveying a respective advertisement and configured to be removeably affixed to a vehicle;
tracking and recording travel of each ad module; and
using the recorded travel of an ad module, determining an advertising display value, and enabling payment to an operator of a vehicle to which the ad module was removeably affixed during travel, the payment being based on the determined advertising display value.

10. A method as in claim 9, wherein the ad module is any of a magnetic placard, an adhesive backed placard, an electro-static placard, or a multi-piece placard.

11. A method as claimed in claim 9, wherein the tracking and recording utilizes a toll road payment system.

12. A method as claimed in claim 11 wherein payment to the vehicle operator is in credits toward toll roads.

13. A method as claimed in claim 9, wherein the step of tracking and recording includes for each ad module:
generating a data signal uniquely identifying the ad module and indicating the vehicle to which the ad module is currently removeably affixed; and
at locations spaced along roadways being traveled by the vehicle, obtaining the generated data signal and recording indication of travel of the corresponding ad module.

14. A method as claimed in claim 13, wherein the step of recording indication of travel includes recording any combination of location, date, or time of travel.

15. A method as claimed in claim 13, wherein the step of generating a data signal includes employing a transponder coupled to one of the ad module and the vehicle.

16. A method as claimed in claim 15, wherein the step of obtaining generated data signals is performed at toll road booths.

17. A system for a vehicle advertising network comprising:
an agency to serve as a distributor between advertisers and participating vehicles;
a service center enabling affixing and/or removing an advertising module placed on a participating vehicle;
a system of signal senders and receivers on one or more roadways to detect participating vehicles and respective advertising modules removeably affixed to participating vehicles; and
a digital processor configured to calculate compensation to operators of participating vehicles based on respective advertising modules removeably affixed to a participating vehicle.

18. A system as claimed in claim 17, wherein the service center is a toll booth on a toll road.

19. A system as claimed in claim 17, wherein the compensation is any combination of credit against motor vehicle fines, electronic funds transfer, or credit toward toll road fees.

20. A system for advertising comprising:
ad module means for providing advertisements in a form removeably affixable to vehicles;
a tracking means for tracking and recording travel of each advertisement per vehicle to which the advertisement is removeably affixed; and
data processing means responsive to the tracking means, and for a given advertisement, the data processing means using the recorded travel of the advertisement to determine an advertising display value, the data processing means enabling payment to an operator of a vehicle to which the given advertisement was removeably affixed during travel, the payment being based on the determined advertising display value.
